(19) United States
(12) Patent Application Publication
(10) Pub. No.: US 2014/0355567 A1
(43) Pub. Date: Dec. 4, 2014

(54) Radio Access Network Sharing

(71) Applicant: VODAFONE IP LICENSING LIMITED, Berkshire (GB)

(72) Inventors: Ralf Irmer, Berkshire (GB); Prakash Bhat, Berkshire (GB)

(21) Appl. No.: 14/366,988

(22) PCT Filed: Dec. 19, 2012
(86) PCT No.: PCT/GB2012/053190

§ 371 Date: Jun. 19, 2014

(30) Foreign Application Priority Data
Dec. 19, 2011 (GB) 1121828.6
Dec. 19, 2011 (GB) 1121835.1

(51) Int. Cl. H04L 5/00; H04W 36/00; H04J 11/00; H04W 8/02; H04W 16/14

(52) U.S. Cl. CPC H04L 5/0032; H04W 8/02; H04W 16/14; H04L 5/0073; H04J 11/0056; H04W 36/0072
USPC 370/331; 370/329

(57) ABSTRACT

The present invention relates to wireless systems, and in particular provides a method of sharing radio resources between a first cell of a first cellular network and a second cell of a second cellular network. Each cell transmits using a respective carrier of a different frequency and each cell uses a respective scheduler to allocate transmissions to a respective plurality of radio resources. The method comprises identifying a transmission for a user attached to the first cell that is available for radio resource allocation by the scheduler of the first cell, where the transmission could be made over the second carrier; and interfacing between the scheduler of the first cell and the scheduler of the second cell, so as to allocate radio resources for use by the second cell to the transmission for the user attached to the first cell.

### TECHNICAL FIELD OF THE INVENTION

The present invention relates to a method of sharing radio resources between a first cell of a first cellular network and a second cell of a second cellular network. The method also concerns a broker system for sharing radio resources and an interfacing system for cellular networks.

### BACKGROUND TO THE INVENTION

Cellular networks are being provided with increasing density, so maximising the efficient use of limited radio resources becomes ever more important. Networks are often provided by different operators. The costs of deploying and maintaining a network are high, but network sharing amongst network operators could significantly reduce these. However, there are large technical and regulatory challenges in implementing successful network sharing. Moreover, the additional cost and complexity involved in implementing network sharing could outweigh any cost savings due to resultant shared resource usage.

To be effective, network sharing approaches should maximise the spectrum used by both networks. In other words, where each cell transmits using a single carrier in the downlink, it is desirable to maximise the peak bit-rate available to users when combining the carriers of more than one network. Improving tracking efficiency and dynamic sharing with higher network capacity is also advantageous.

There are a number of existing approaches for sharing resources between cellular networks. One approach is the sharing of passive elements, such as towers, backhaul, air conditioning, etc. The potential savings here are limited.

A second approach is for different cellular networks to use the same frequency band, but different public land mobile network (PLMN) codes. This has practical problems, for instance because some user equipment (UE) handsets do not display the correct operator in these cases. Moreover, regulators are reluctant to allow more than one operator to use a single frequency band.

A third approach is for the different networks to use different carriers on different frequency bands, but using shared radio frequency and base band equipment. In these cases, the network traffic may be split out to different core networks. In other words, the data is split between the networks after the radio network controller (RNC). Regulators also disapprove of this approach. Moreover, there is essentially no sharing of radio resources, since each spectrum band is only available to the users of the respective network. In other words, no dynamic sharing of spectrum resources is possible.

A final option is to allow roaming between different networks within the same geographical country. Again, regulators do not usually allow such an approach except in limited cases.

Sharing of spectrum and equipment between operators can theoretically provide improved peak data-rates to users and increase overall network throughput or capacity. Moreover, trunking efficiency can be obtained using such approaches to exploit differences in traffic demand between different networks. The existing technologies discussed above do not take advantage of these theoretical improvements.

Other proposals for spectrum sharing exist. These involve joint operation of a frequency band by multiple network operators. However, regulatory constraints have been applied to these approaches and operators completely lose control over their spectrum, which is disadvantageous. For example, “Dynamic Spectrum Sharing Algorithm between Two UMTS Operators in the UMTS Extension Band”, Salami, Thilakawardana, Tafazolli, ICC Workshops 2009, p. 1-6, discusses a network-based agent that could reserve the available number of codes to roaming users from other networks, this might allow flexible sharing of resources, but again may involve regulatory complexities.

### SUMMARY OF THE INVENTION

Against this background, the present invention provides a method of sharing radio resources between a first cell of a first cellular network and a second cell of a second cellular network. The first and second cells each transmit using a respective carrier of a different frequency. Each cell uses a respective scheduler to allocate transmissions to a respective plurality of radio resources. The method comprises: identifying a transmission for a user attached to the first cell that is available for radio resource allocation by the scheduler of the first cell, where the transmission could be made over the second carrier (a carrier of the second cell); and interfacing between the scheduler of the first cell and the scheduler of the second cell, so as to allocate radio resources for use by the second cell to the transmission for the user attached to the first cell.

In this way, the second cell offers resources to the first network on a dynamic basis. The second network carries out the scheduling of its transmissions (preferably all of its transmissions), giving the network operator full control. Moreover, this separate control of networks is positive from a regulatory perspective. Identifying that the transmission could be made over the second carrier may comprise establishing that the user can receive transmission of the carrier from the second cell.

Optionally, the steps of identifying a transmission and interfacing between schedulers can be carried out by a separate entity, for example a structurally-distinct broker. Alternatively, the steps of identifying and interfacing can be carried out between the first scheduler and second scheduler directly. A protocol may be used to interface between the first scheduler and the second scheduler.

Preferably, the method further comprises: transmitting control data over the first carrier. The control data may identify that the transmission for the user attached to the first cell is being made over the second carrier. As a result, the operator of the first cellular network retains responsibility for transmission of all control data. Conversely, the operator of the second cellular network may not transmit control data relating to transmissions for users of the first cellular network. This can maintain a clear distinction between the first and second cellular networks. In other words, the first cellular network does not offer any service on the second cellular network, but simply uses some radio resources of the carrier of the second cell in addition to the carrier of the first cell. This approach is more acceptable to regulators than other existing radio resource sharing approaches. This approach allows each operator to retain full control over its spectrum whilst allowing certain resources to be used by another operator for a well defined duration.

Optionally, the control data transmitted over the first carrier further comprises system information for the first cell. Then, the method may further comprise: transmitting control data over the second carrier, comprising system information for the second cell. This differs from known carrier aggregation techniques. Each carrier transmits system information for a distinct cell. Advantageously, the first and second carriers transmit a different physical cell ID.

In some embodiments, the step of identifying a transmission is based on one or more of: a traffic demand for the first cell; an achievable data rate or modulation and coding scheme per resource element for the first cell; channel quality information for the first cell; channel quality information for the second cell; traffic type of the transmission; network load or utilisation information for the first cell; and network or utilisation information for the second cell.

Preferably, the step of identifying a transmission that could be made over the second carrier comprises determining that making this transmission over the second carrier results in more efficient communication of this transmission or another transmission than when this transmission is made over the first carrier. The transmission may be made more efficiently over the second carrier in a number of different cases. For example, the step of identifying a transmission that could be made over the second carrier may comprise identifying a transmission that is susceptible to interference from transmissions of a third cell. This could be the case if interference arises due to coexistence with a cell in a neighbouring frequency band. Such a situation might arise where a frequency division duplex (FDD) cell operates in an adjacent frequency band to a time division duplex (TDD) cell, especially where it is the downlink carrier of the FDD cell that is adjacent the TDD cell frequency band.

In embodiments, the first cellular network comprises the third cell as well as the first cell. The third cell may transmit using a carrier at the same frequency as the carrier of the first cell. This can apply in the case where one of the first and third cells is a macro-cell. The other may then be a micro-cell or a pico-cell.

Advantageously, the method further comprises: receiving a plurality of transmissions for users of the first cell at the scheduler of the first cell, including the transmission that could be made over the second carrier; and allocating radio resources of the first cell to each of the plurality of transmissions, except for the transmission that could be made over the second carrier. Allocating radio resources may comprise: scheduling the transmission in time and frequency; determining appropriate modulation and coding for the transmission; and applying the scheduled and determined information. Each transmission may demand a minimum quality of service. When all other transmissions have been allocated, insufficient radio resources may be available to provide the quality of service demanded by the transmission that could be made over the second carrier. The step of identifying the transmission may comprise this process.

Beneficially, the plurality of radio resources for each of the first cell and second cell may comprise: frequency blocks; time blocks; and code blocks associated with the respective carrier. It may be assumed that each frequency block, time block and code block is orthogonal to each other frequency block, time block and code block respectively.

Advantageously, the carrier of the first cell and the carrier of the second cell are adjacent in frequency. By adjacent, it will be understood that the two carriers are substantially non-overlapping and the frequency range of the first carrier has substantially the same common limiting point as the frequency range of the second carrier.

Optionally, the first carrier and second carrier both use the same radio access technology. This radio access technology is preferably Orthogonal Frequency Division Multiplex (OFDM) or Orthogonal Frequency Division Multiple Access (OFDMA). However, Code Division Multiple Access (CDMA), Frequency Division Multiple Access (FDMA) and Time Division Multiple Access (TDMA) can optionally be used. In further instances, the carriers may have different bandwidth, may be different releases of the same radio access technology or may be different technologies altogether: e.g. LTE and WiFi or LTE and WiMAX.

In some embodiments, the method further comprises attaching the user to the first cellular network using transmissions over a carrier at the same frequency as the carrier of the first cell, prior to the step of identifying a transmission that could be made over the second carrier. In other words, access to the first cellular network is only available through transmissions made by cells of that cellular network. These transmissions are made in the same frequency range. That frequency range is different from the frequency range used by the second cellular network. Beneficially, the step of attaching the user to the first cellular network uses transmissions over the carrier of the first cell.

The method of the present invention can be advantageous in some specific circumstances. For example, the method may further comprise: making the transmission to the user attached to the first cell using the carrier of the second cell, subsequent to the step of interfacing; identifying that the user is moving outside the geographical coverage range of the first cellular network, but within the geographical coverage range of the second cellular network; carrying out handover of the user from the first cell to a cell of the second cellular network; and transmitting to the user using the carrier of the cell of the second cellular network. In this approach, the user (that is, a UE) may be attached to a cell of the first cellular network operative with a first carrier frequency. This can then be followed by handover to a second cell of the first cellular network, having a geographical coverage range overlapping with a cell of the second cellular network. Whilst attached to this second cell of the first cellular network, resource sharing takes place and the UE receives data through the cell of the second cellular network, which is on a second carrier frequency. Subsequently, the UE moves outside the geographical coverage range of the second cell of the first cellular network and into an area where the first cellular network has no coverage. The movement of the UE to an area outside the geographical coverage range of the first cellular network can happen before or after movement of the UE to the second cell. Handover of the UE to a cell of the second cellular network can then take place at a later stage, this cell having a carrier at the second carrier frequency. This advantageously facilitates more efficient handover of the UE between cells with different carrier frequencies. In particular, this approach can beneficially be applied when it is identified that handover of the UE from the first cellular network to the second cellular network may be required in future.

In another aspect, the present invention may be found in a computer program, configured to carrying out a method described herein when operated on a processor.

In a further aspect, there may be provided a broker system for sharing radio resources between a first cell of a first cellular network and a second cell of a second cellular network, the first and second cells each being arranged to transmit using a respective carrier of a different frequency and each cell comprising a respective scheduler configured to allocate transmissions to a respective plurality of radio resources. The broker may be configured to identify a transmission for a user attached to the first cell that is available for radio resource allocation by the scheduler of the first cell, where the transmission could be made to the user over the second carrier. The broker may be further configured to interface between the scheduler of the first cell and the scheduler of the second cell, so as to allocate radio resources for use by the second cell to the transmission for the user attached to the first cell.

In another aspect, the present invention may provide an interfacing system for cellular networks, comprising: a first cell of a first cellular network, configured to transmit using a carrier of a first frequency and having a first scheduler to allocate transmissions to a first plurality of radio resources; a second cell of a second cellular network, configured to transmit using a carrier of a second frequency, different from the first frequency and having a second scheduler to allocate transmissions to a second plurality of radio resources; and a broker coupled between the first and second schedulers and configured to identify a transmission for a user attached to the first cell that is available for radio resource allocation by the scheduler of the first cell, where the transmission could be made over the second carrier. The broker is further configured to interface between the first and second schedulers, so as to allocate radio resources for use by the second cell to the transmission for the user attached to the first cell. Optionally, the broker may comprise a part of the first scheduler and a part of the second scheduler. Alternatively, the broker may be separate from the first and second schedulers.

In an advantageous implementation, the broker will implement policies on how resources are shared between the cellular networks. It will implement suitable counters to keep track on how many resources are used between the networks and to check the balance against pre-defined limits. In this way, the mutual exchange of information can be defined locally within one base station. The broker may also exchange information with counters in an entire network (i.e. countrywide) in order to keep track of countrywide exchange of data elements. Furthermore, the counters in the broker can be used to support charging between the operators of the networks or to support service level agreements.

It will be understood that the broker and interfacing system can optionally comprise features used to implement any of the method features described above. Also, any combination of the individual method features or apparatus features described may be implemented, even though not explicitly disclosed.

### BRIEF DESCRIPTION OF THE DRAWINGS

The invention may be put into practice in various ways, one of which will now be described by way of example only and with reference to the accompanying drawings in which:

FIG. 1 shows a schematic diagram of an interfacing system for cellular networks;

FIG. 2 shows an example of transmission modes for two cells in accordance with the embodiment of FIG. 1; and

FIG. 3 illustrates a scenario in which the invention described in FIGS. 1 and 2 can advantageously be applied.

### DETAILED DESCRIPTION OF A PREFERRED EMBODIMENT

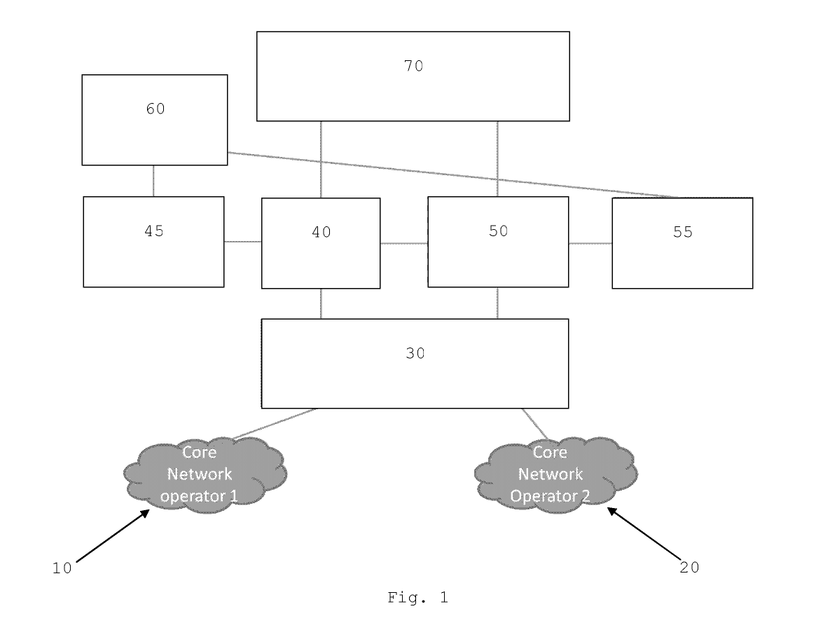

Referring first to FIG. 1, there is shown an interfacing system for cellular networks in accordance with the present invention. The interfacing system relates to two different cellular networks, operated separately. The interfacing system comprises: a core network of a first cellular network 10; a core network of a second cellular network 20; a common transmission block 30; a base band processing block for the first cell 40; a base band processing block for the second cell 50; a scheduler for the first cell 45; a scheduler for the second cell 55; a broker 60; and an RF and antenna block 70.

The first cellular network has a first cell operated to transmit with a first carrier on the downlink. The second cellular network has a second cell operated to transmit on the downlink using a second carrier. Both cells use the Third Generation Partnership Project (3GPP) Long Term Evolution (LTE) system. The second cell may offer resources (i.e. time-frequency blocks, resource elements, time slots, subcarriers) to the first cell on a dynamic basis when they are not required. This is achieved by coupling the scheduler for the first cell 45 and the scheduler for the second cell 55.

To accomplish this, a broker 60 is introduced between the scheduler for the first cell 45 and the scheduler for the second cell 55. This broker is advantageously a separate component with its own logic, although it can alternatively comprise a protocol interface between the two schedulers, together with logic in one or both of the schedulers. Either way, the logic can be implemented in hardware, software or any combination of the two.

The broker is designed to implement resource sharing in a way that is similar to existing carrier aggregation technologies and similar to existing technologies for coordinated scheduling in heterogeneous networks. Carrier aggregation is known for 3GPP LTE (Release 10), for example as discussed in 3GPP TR 36.814 v1.2.1. However, this form of carrier aggregation applies to multiple carriers for the same operator. In other words, the carriers are scheduled by the same scheduler. In contrast, the carriers are scheduled by different schedulers for the embodiment shown here, as described above.

The broker 60 can have a number of input parameters. These may include: the additional traffic demands; the interference situation; channel information for the downlink channels of the first cell; channel information for the downlink channels of the second cell; network load or utilisation; and traffic type. The interference situation may be defined in terms of an achievable data rate or an achievable modulation and coding scheme per resource block or element. Any one or more of these input parameters can be used to identify transmissions that could be made using the second cell.

The second cell may offer resource elements to the first cell for a certain amount of time. It may further impose a scheduling restriction on itself for these elements. The first cell can make use of these resource elements with mechanisms of carrier aggregation. For example, carrier aggregation in existing technologies allows for aggregating carriers that are contiguous or non-contiguous, intra-band or inter-band.

In existing carrier aggregation schemes, a primary cell and secondary cell are defined. The primary cell (Pcell) defines the channels for random access for users of the cellular network and is where security authentication is performed. The primary cell is also used for mobility. Information (a frequency or cell index) regarding the secondary cell (Scell) is indicated on the carrier of the primary cell. The carrier of the Scell can be added or removed at any time. Existing specifications for carrier aggregation also define cross-carrier scheduling that allows for a control channel and one carrier to identify resource scheduling on the other carrier.

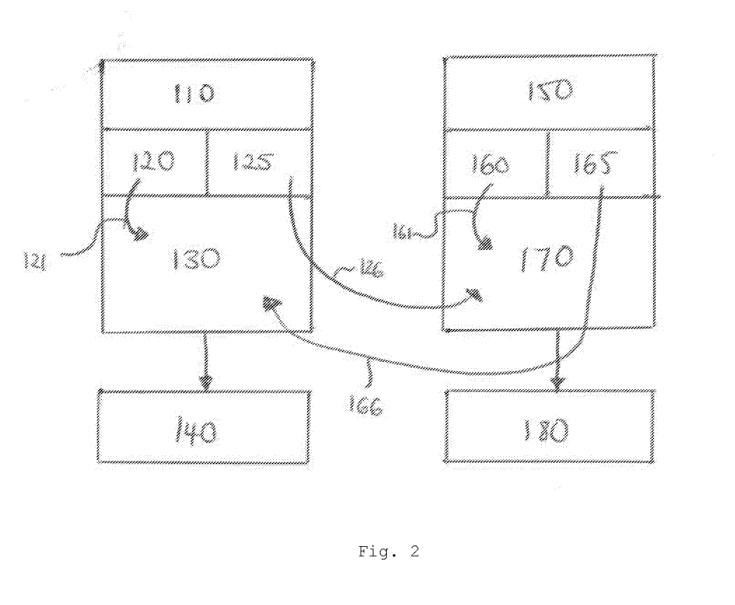

Referring next to FIG. 2, there is shown an example of transmission modes for two cells in accordance with the embodiment of FIG. 1. The first cell has a first carrier 140 and the second cell has a second carrier 180. The information for transmission on the first carrier 140 comprises: operator-specific information 110; a first part of the physical downlink control channel (PDCCH) 120; a second part of the PDCCH 125; and a physical downlink shared channel (PDSCH) 130. Similarly, information for the second carrier 180 comprises: operator-specific information 150; a first part of a PDCCH 160; a second part of the PDCCH 165; and a PDSCH 170.

The first part of the PDCCH 120 for the first cell controls the PDSCH 130 of the first cell. This is illustrated through link 121. The second part of the PDCCH 125 of the first cell controls the PDSCH 170 of the second cell, illustrated by link 126. Correspondingly, the first part of the PDCCH 160 for the second cell controls the PDSCH 170 of the second cell, shown by link 126. The second part of the PDCCH 165 for the second cell controls the PDSCH 130 of the first cell, illustrated by link 166. Thus, the PDSCH 130 of the first cell and the PDSCH 170 of the second cell are flexibly scheduled from the PDCCH of the other carrier, in accordance with an agreed sharing policy.

Existing carrier aggregation techniques are not sufficient for this. To achieve this effect, all of the system information (MIB and SIB1, SIB2 . . . SIBn) are transmitted on the second carrier 180, together with parameters configured for the second cell. A separate physical cell ID is allocated on each of the first carrier 140 and second carrier 180.

One advantage of this approach is that the control signal for the first cell is only transmitted on the first carrier 140. Also, admission to the cellular network of the first cell is only available via the first carrier 140. This may have advantages in terms of the operation within a certain frequency band by an operator. In particular, regulators may approve of this more readily, since the network operator of the first cell does not strictly offer a service on the second carrier 180, but simply uses some resources of the second carrier 180 in addition to the first carrier 140.

Terminals that do not support carrier aggregation can coexist with this approach. Transmissions for such terminals can be scheduled on only the carrier of the network to which they are attached. Nevertheless, they receive and send their control information as normal.

Further advantages of the present invention include the enablement of scheduling resources in order to mitigate interference on certain resource blocks. For example, if interference arises due to coexistence with a system on a neighbouring band, intelligent scheduling can mitigate the interference. For example, where a Frequency Division Duplex (FDD) system operates in the downlink on one frequency band and a Time Division Duplex (TDD) system operates in the downlink and uplink on an adjacent frequency band, interference can result to downlink transmissions. Intelligent scheduling may result in a UE susceptible to interference from the system on the adjacent frequency having resource blocks allocated on another carrier that is not adjacent to the interfering system.

The invention also enables more efficient operation of heterogeneous networks, i.e. networks with different hierarchy layers, such as macro-cells, micro-cells, pico-cells and femto-cells. For such configurations, it is preferable for the macro-cell to have two transmission carriers available to it, one of which can be configured as an escape carrier. The escape carrier may be free from interference from another cell in the network with a carrier of the same frequency. For instance, if the network operator of the first cell also has a third cell that is a pico-cell, it may be possible for the first cell to use the carrier of a second cell on a second network as an escape carrier. This escape carrier would potentially be free from interference from the carrier of the pico-cell. Particular users in a cell-edge situation between the macro-cell and pico-cell may be identified and transmissions for these users scheduled on the carrier of the second cell, belonging to the second network.

The invention may also provide a more efficient transmission bandwidth for multiple operators, where the carriers are on adjacent frequencies. By adjacent frequencies, it may be understood that the frequency range of the first carrier and frequency range of the second carrier are not substantially overlapping, or essentially distinct. Adjacent frequencies could also refer to two frequency ranges, each having a respective lower limit and upper limit, the upper limit of one frequency range being substantially the same as the lower limit of the other frequency range. Optionally, there can be a gap between the upper limit of the first frequency range and the lower limit of the second frequency range, but the gap is typically smaller than the width of either the first frequency range or a second frequency range.

For aggregation of non-contiguous components carriers, each carrier should meet existing LTE spectrum requirements, such as an emission mask, adjacent channel leakage and spurious emission requirements, to provide backwards compatibility and ensure minimal interference to adjacent carriers. However, these requirements are relaxed for continuous carrier aggregation and hence, more efficient use of available spectrum is possible if the two carriers are aggregated. This is discussed in 3GPP TR 36.815, Section 5.2.2.5. Such an approach might be achieved for aggregated carriers of the present invention, where the aggregation is co-ordinated by broker 60.

Although an embodiment of the invention has been described above, the skilled person will recognise that various modifications or adjustments can be made. For example, aggregation of non-adjacent carriers is possible. It will be understood that both first and second cells may transmit data for users of the other cell. Other forms of carrier aggregation may also be considered, for example, where the first cell only identifies that transmissions for a UE are being made on the carrier of the second cell and the second cell transmits the remaining control data.

Whilst the embodiment shown herein uses a common transmission block 30 between the cells, it will be recognised that separate transmission blocks for each cell can alternatively be implemented. Similarly, separate RF and antenna blocks might be used in place of the common RF and antenna block 70 described above.

The invention may also permit a business model, where an operator (or investor group) facilitates deployment and maintenance (CAPEX and OPEX) and further leases services to other operators. With this invention, flexible spectrum partitioning may be supported on a per-operator basis. For example, a first mobile virtual network operator (MVNO) may be restricted to 3GPP Release 8 features, whilst a second MVNO may be provided with Release 8 and Release 10 features.

Another possible use of the broker 60 in the context of the present invention is for media broadcasting. If a media broadcaster using multimedia broadcast multicast service (MBMS) on a dedicated carrier wishes to use a unicast carrier occasionally, for example for interactive viewing, this would require access to the unicast carrier. Instead of the broadcaster dedicating a carrier for unicast services, it can instead use a unicast carrier of another cellular operator. The broker 60 could co-ordinate with the cell of the unicast carrier, to provide additional resources for interactive services.

A further advantage of the present invention involves situations where limited national roaming is provided. For example, carrier aggregation between cells may be applied only at cell borders of two operators with national roaming agreement. This can provide seamless handover and prevent a problem where the user is stuck with a sub-optimal cell in a visited network.

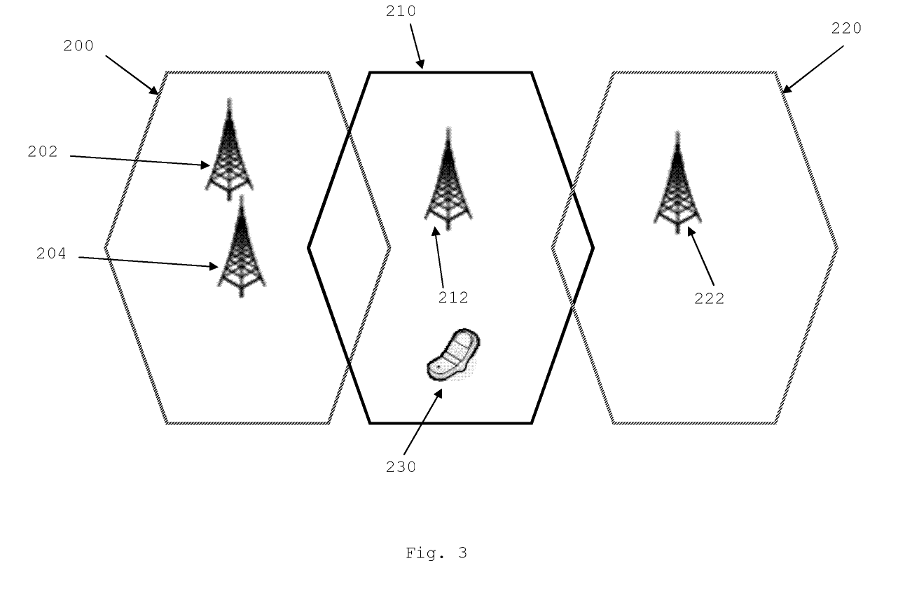

Referring to FIG. 3, there is illustrated a scenario in which the invention described in FIGS. 1 and 2 can advantageously be applied, in line with this idea. FIG. 3 shows a first cell area 200, a second cell area 210 and a third cell area 220. In the first cell area 200, two cells are provided. The first cell 202 is provided by a first network operator and has a first carrier frequency. The second cell 204 is provided by a second network operator and has a second carrier frequency. In the second cell area 210, the first network operator and second network operator use a network sharing arrangement to provide a combined cell 212. The combined cell 212 has a first carrier at the first frequency and a second carrier at the second frequency. In the third cell area 220, a fourth cell 222 is available. This fourth cell is operated only by the second network operator and has a carrier on the second frequency.

A UE 230 from the first network operator may start in the first cell area 200. It is initially attached to the first cell 202 on the first carrier frequency. UE 230 then moves from the first cell area 200 towards the third cell area 220. This movement is recognised by the first network operator. Moving from the first cell area 200 to the second cell area 210, the UE 230 is handed over from the first cell 202 to the combined cell 212. Once attached to the combined cell 212, the UE begins to receive transmissions over the second carrier frequency as part of the sharing arrangement.

The UE is then handed over from the combined cell 212 to the fourth cell 222 in the third cell area 220. This is an intra-frequency handover and the fourth cell 222 is a roaming cell for the UE 230. This intra-frequency handover can be much more straightforward than an inter-frequency handover, since no inter-frequency measurements, compressed mode, data loss or core drop will be involved. In this way, the first network operator which is responsible for aggregating the carriers for transmitting to the UE 230 in the combined cell 212, steers the UE 230 to the correct frequency layer prior to handing over the user to the roaming network.

Based on the above, if it is not desirable for an operator to have nationwide sharing of a network, the operator may perform sharing only in areas challenged by a site constraint or where there are economic reasons, for example in rural areas.

Although an embodiment of the invention has been described above, the skilled person will recognise that various modifications or adjustments can be made. For example, it will be understood that the various cells (first cell, second cell, third cell, fourth cells) may correspond to any type of cells of heterogeneous networks, such as macro-cells, micro-cells, pico-cells and femto-cells.

1. A method of sharing radio resources between a first cell of a first cellular network and a second cell of a second cellular network, the first and second cells each transmitting using a respective carrier of a different frequency and each cell using a respective scheduler to allocate transmissions to a respective plurality of radio resources, the method comprising:
identifying a transmission for a user attached to the first cell that is available for radio resource allocation by the scheduler of the first cell, where the transmission could be made over the second carrier; and
interfacing between the scheduler of the first cell and the scheduler of the second cell, so as to allocate radio resources for use by the second cell to the transmission for the user attached to the first cell.

2. The method of claim 1, further comprising:
transmitting control data over the first carrier, the control data identifying that the transmission for the user attached to the first cell is being made over the second carrier.

3. The method of claim 2, wherein the control data transmitted over the first carrier further comprises system information for the first cell, the method further comprising:
transmitting control data over the second carrier, comprising system information for the second cell.

4. The method of claim 1, wherein the step of identifying a transmission is based on one or more of: a traffic demand for the first cell; an achievable data rate or modulation and coding scheme per resource element for the first cell; channel quality information for the first cell; channel quality information for the second cell; traffic type of the transmission; network load or utilization information for the first cell; and network load or utilization information for the second cell.

5. The method of claim 1, wherein the step of identifying a transmission that could be made over the second carrier comprises determining that making this transmission over the second carrier results in more efficient communication of this transmission or another transmission than when this transmission is made over the first carrier.

6. The method of claim 5, wherein the step of identifying a transmission that could be made over the second carrier comprises identifying a transmission that is susceptible to interference from transmissions of a third cell.

7. The method of claim 6, wherein the first cellular network comprises the third cell, the third cell transmitting using a carrier at the same frequency as the carrier of the first cell.

8. The method of claim 1, further comprising:
receiving a plurality of transmissions for users of the first cell at the scheduler of the first cell, including the transmission that could be made over the second carrier; and;
allocating radio resources of the first cell to each of the plurality of transmissions, except for the transmission that could be made over the second carrier.

9. The method of claim 1, wherein the plurality of radio resources for each of the first cell and second cell comprise: frequency blocks; time blocks; and code blocks associated with the respective carrier.

10. The method of claim 1, wherein the carrier of the first cell and the carrier of the second cell are adjacent.

11. The method of claim 1, wherein the first cell and the second cell use Orthogonal Frequency Division Multiplex, OFDM, Radio Access Technology.

12. The method of claim 1, further comprising:
attaching the user to the first cellular network using transmissions over a carrier at the same frequency as the carrier of the first cell, prior to the step of identifying a transmission that could be made over the second carrier.

13. The method of claim 1, further comprising:
making the transmission to the user attached to the first cell using the carrier of the second cell, subsequent to the step of interfacing;
identifying that the user is moving outside a geographical coverage range of the first cellular network, but within a geographical coverage range of the second cellular network;
carrying out handover of the user from the first cell to a cell of the second cellular network; and
transmitting to the user using the carrier of the cell of the second cellular network.

14. A computer program, configured to carry out the method of claim 1 when operated on a processor.

15. An interfacing system for cellular networks, comprising:
a first cell of a first cellular network, configured to transmit using a carrier of a first frequency and having a first scheduler to allocate transmissions to a first plurality of radio resources;
a second cell of a second cellular network, configured to transmit using a carrier of a second frequency, different from the first frequency and having a second scheduler to allocate transmissions to a second plurality of radio resources; and
a broker, coupled between the first and second schedulers and configured to identify a transmission for a user attached to the first cell that is available for radio resource allocation by the scheduler of the first cell, where the transmission could be made over the second carrier, and further configured to interface between the first and second schedulers, so as to allocate radio resources for use by the second cell to the transmission for the user attached to the first cell.
